(19) United States
(12) Patent Application Publication
(10) Pub. No.: US 2019/0061905 A1
(43) Pub. Date: Feb. 28, 2019

(54) AIRFOIL

(71) Applicants: David Victor Bosse, JR., Winters, CA (US); Thomas James Bosse, Meridian, ID (US); Donald Warren Bosse, Eagle, ID (US)

(72) Inventors: David Victor Bosse, JR., Winters, CA (US); Thomas James Bosse, Meridian, ID (US); Donald Warren Bosse, Eagle, ID (US)

(21) Appl. No.: 15/957,907

(22) Filed: Apr. 20, 2018

Related U.S. Application Data
(60) Provisional application No. 62/552,202, filed on Aug. 30, 2017.

(51) Int. Cl. B64C 3/14; B64C 23/00

(52) U.S. Cl. CPC B64C 3/14; B64C 2003/145; B64C 2003/147; B64C 23/005

(57) ABSTRACT

An airfoil that comprises a chamber having a forward-facing chamber opening may result in increased lift and decreased drag relative to a standard airfoil having deployed flaps, for example on an airplane wing. In embodiments, the chamber opening is located on or near the pressure surface of the airfoil. The airfoil chamber may enhance the lift-generating ability of the airfoil due to increased pressure at the pressure surface.

### CROSS REFERENCE TO RELATED APPLICATION

This application claims the filing date benefit of U.S. Provisional Patent Application Serial No. 62/552,202, filed on Aug. 30, 2017, and titled “NON-RIGID EFFECT GENERATOR,” the entire contents of which are hereby incorporated by reference.

### BACKGROUND

### Technical Field

The present disclosure relates generally to airfoils. In particular, this disclosure relates to improvements to airfoil shapes.

### Description of Related Art

Generally, airfoils in the form of wings, turbine blades, propeller blades and/or rotors, and other similar implementations are used to generate lift and/or induce movement in air or other fluids. Airfoils generate lift through generation of a pressure differential between the “suction surface” and “pressure surface” of the airfoil. In cases where the airfoil is a wing, the upper surface of the airfoil may be referred to as the suction surface, while the lower surface may be referred to as the pressure surface due to the fact that lift results from higher fluid pressure under the wing than pressure above the wing.

In some types of foils, such as turbine blades, winglets, and the like, the pressure side of the airfoil may not necessarily be the lower side. Likewise, the suction side of such an airfoil may not be the upper side.

One common goal for designers of airfoils is to maximize lift while minimizing drag as compared to a typical airfoil with deployed flaps. Reduced drag in an airfoil may result in improved efficiency, which can have economical and environmental benefits.

### SUMMARY

In one embodiment, an airfoil is disclosed. The airfoil has a chamber and a chamber opening. The chamber opening faces a forward direction of travel of the airfoil.

In another embodiment, a method of generating lift is disclosed. The method includes directing an aircraft. The aircraft has an airfoil. The airfoil includes a chamber and a chamber opening. The chamber opening faces the forward direction of the aircraft.

In another embodiment, an airfoil is disclosed. The airfoil has a chamber enclosure, a chamber opening, and an end barrier at an end of the chamber. The chamber opening faces a forward direction of the airfoil. The end barrier is essentially perpendicular to a length of the chamber and essentially parallel to the forward direction of the airfoil.

The present disclosure will now be described more fully with reference to the accompanying drawings, which are intended to be read in conjunction with both this summary, the detailed description, and any preferred or particular embodiments specifically discussed or otherwise disclosed. This disclosure may, however, be embodied in many different forms and should not be construed as limited to the embodiments set forth herein; rather, these embodiments are provided by way of illustration only so that this disclosure will be thorough, and fully convey the full scope of the invention to those skilled in the art.

### BRIEF DESCRIPTION OF THE DRAWINGS

Non-limiting and non-exhaustive embodiments of the present disclosure are described with reference to the following figures, wherein like reference numerals refer to like parts throughout the various views unless otherwise specified.

FIG. 1 is a perspective view of an airfoil according to various embodiments of the present disclosure;

FIG. 2 is a front view of an airfoil according to embodiments of the present disclosure;

FIG. 3 is a rear view of an airfoil according to embodiments of the present disclosure;

FIG. 4 is a cutaway view of an airfoil according to embodiments of the present disclosure;

FIG. 5 is a bottom view of an airfoil with a chamber according to one embodiment of the present disclosure;

FIG. 6 is a cutaway view depicting a redirect channel according to one embodiment of the present disclosure; and

FIG. 7 is a cutaway view showing an airfoil leading edge according to embodiments of the present disclosure.

Corresponding reference characters indicate corresponding components throughout the several views of the drawings. Skilled artisans will appreciate that elements in the figures are illustrated for simplicity and clarity and have not necessarily been drawn to scale. For example, the dimensions of some of the elements in the figures may be exaggerated relative to other elements to help to improve understanding of various embodiments of the present disclosure. Also, common but well-understood elements that are useful or necessary in a commercially feasible embodiment are often not depicted in order to facilitate a less obstructed view of these various embodiments of the present disclosure.

### DETAILED DESCRIPTION

In the following description, reference is made to exemplary embodiments in which the disclosure may be practiced. These embodiments are described in sufficient detail to enable those skilled in the art to practice the concepts disclosed herein, and it is to be understood that modifications to the various disclosed embodiments may be made, and other embodiments may be utilized, without departing from the spirit and scope of the present disclosure. The following detailed description is, therefore, not to be taken in a limiting sense.

Reference throughout this specification to “one embodiment,” “an embodiment,” “one example,” or “an example” means that a particular feature, structure, or characteristic described in connection with the embodiment or example is included in at least one embodiment of the present disclosure. Thus, appearances of the phrases “in one embodiment,” “in an embodiment,” “one example,” or “an example” in various places throughout this specification are not necessarily all referring to the same embodiment or example. Furthermore, the particular features, structures, or characteristics may be combined in any suitable combinations and/or sub-combinations in one or more embodiments or examples.

Although the term “airfoil” is used throughout the present disclosure, it should be understood that the term “airfoil” may include foils that function in other fluid media. For example, the term “airfoil” may be readily interchangeable with the term “hydrofoil” or other types of foils. Accordingly, the term “airfoil” does not limit the present disclosure only to foils that function in air as a fluid medium.

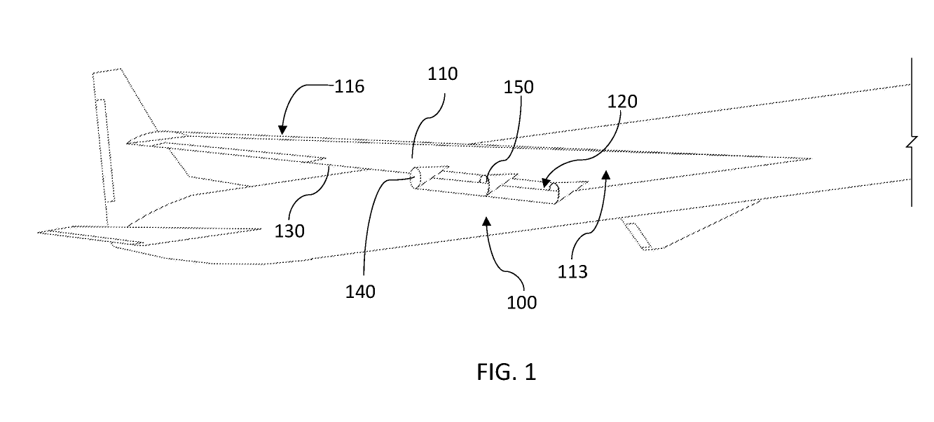

Referring to FIG. 1, embodiments of the present disclosure include a chamber 100 at and/or on the pressure surface 113 of an airfoil 110, with a chamber opening 120 facing a forward direction. Such a chamber 100 may result in an increase of pressure at the pressure surface 113 relative to pressure at the suction surface, thereby increasing lift generated by the airfoil 110.

As used throughout the present disclosure, the forward-facing direction of an airfoil may be defined by the direction of travel of the airfoil, such that oncoming fluid is separated to either the pressure surface or the suction surface by the airfoil leading edge as the airfoil travels through the fluid. As an example, for wings attached to an aircraft, the forward direction of the wing may generally coincide with the forward direction of the aircraft. Likewise, the trailing edge of the airfoil may be defined to be the rear edge, where the airflow that was separated by the pressure surface and the suction surface rejoins.

As used throughout the present disclosure, the chord of an airfoil may be defined as a line extending from the leading edge of an airfoil to the trailing edge. As used throughout the present disclosure, the span of an airfoil may be defined as the end-to-end length of the airfoil. In cases where the airfoil comprises a wing, the airfoil span may be defined as the length from one wing tip to the other wing tip.

In embodiments of the present disclosure, a forward-facing chamber opening 120 may be along part or all of the span of the airfoil 110. In embodiments, the chamber opening 120 is at the trailing edge 130 of the airfoil. In other embodiments, the chamber opening 120 is forward of the trailing edge 130.

In various embodiments of the present disclosure, the degree of forward placement of the chamber and/or chamber opening on an airfoil may be selected according to desirable traits of the airfoil. In some embodiments, when comparing forward placement of the chamber on two otherwise identical airfoils, the airfoil with a chamber more forward may generate less lift than the airfoil with a chamber more rearward. In other words, the area of an airfoil pressure surface that is in front of the chamber may have a direct relationship with lift generation.

As described herein, forward and/or rearward placement of the airfoil chamber may be defined as a percentage of the distance between the trailing edge and the leading edge of the airfoil, as measured along a chord line of the airfoil. In some cases, said chord line may be parallel to a direction of travel for the airfoil. In some cases, said chord line may be perpendicular to the span of the airfoil. In one example embodiment, the chamber opening is forward from the trailing edge approximately 10% of the distance between the trailing edge and the leading edge. In one example embodiment, the chamber opening is forward from the trailing edge between 0% and 5%, inclusive, of the distance between the trailing edge and the leading edge. In one example embodiment, the chamber opening is forward from the trailing edge between 5% and 10%, inclusive, of the distance between the trailing edge and the leading edge. In one example embodiment, the chamber opening is forward from the trailing edge between 10% and 15%, inclusive, of the distance between the trailing edge and the leading edge. In one example embodiment, the chamber opening is forward from the trailing edge between 15% and 20%, inclusive, of the distance between the trailing edge and the leading edge. In one example embodiment, the chamber opening is forward from the trailing edge between 20% and 25%, inclusive, of the distance between the trailing edge and the leading edge. In one example embodiment, the chamber opening is forward from the trailing edge between 25% and 30%, inclusive, of the distance between the trailing edge and the leading edge. In one example embodiment, the chamber opening is forward from the trailing edge between 30% and 40%, inclusive, of the distance between the trailing edge and the leading edge. In one example embodiment, the chamber opening is forward from the trailing edge between 40% and 50%, inclusive, of the distance between the trailing edge and the leading edge. In one example embodiment, the chamber opening is forward from the trailing edge between 50% and 60%, inclusive, of the distance between the trailing edge and the leading edge. In one example embodiment, the chamber opening is forward from the trailing edge between 60% and 70%, inclusive, of the distance between the trailing edge and the leading edge. In one example embodiment, the chamber opening is forward from the trailing edge between 70% and 80%, inclusive, of the distance between the trailing edge and the leading edge. In one example embodiment, the chamber opening is forward from the trailing edge between 80% and 90%, inclusive, of the distance between the trailing edge and the leading edge. In one example embodiment, the chamber opening is forward from the trailing edge between 90% and 100%, inclusive, of the distance between the trailing edge and the leading edge.

According to various embodiments of the present disclosure, the chamber size may be selected according to desirable traits of the airfoil. Generally, a larger chamber size may result in increased lift and/or pressure at the airfoil pressure surface. In one embodiment, the chamber has a cylindrical shape with a radius of approximately 6 inches. In another embodiment, the chamber has a radius of approximately 10 inches. In one embodiment, the chamber has a radius of less than 6 inches. In one embodiment, the chamber has a radius between 6 and 12 inches, inclusive. In one embodiment, the chamber has a radius between 12 and 18 inches, inclusive. In one embodiment, the chamber has a radius between 18 and 36 inches, inclusive. In one embodiment, the chamber has a radius between 3 and 5 feet, inclusive. In one embodiment, the chamber has a radius between 5 and 10 feet, inclusive. In one embodiment, the chamber has a radius between 10 and 15 feet, inclusive. In one embodiment, the chamber has a radius between 15 and 20 feet, inclusive. In one embodiment, the chamber has a radius between 20 and 25 feet, inclusive. In one embodiment, the chamber has a radius between 25 and 30 feet, inclusive. In one embodiment, the chamber has a radius between 30 and 35 feet, inclusive. In one embodiment, the chamber has a radius between 35 and 40 feet, inclusive. In one embodiment, the chamber has a radius between 40 and 45 feet, inclusive. In one embodiment, the chamber has a radius between 45 and 50 feet, inclusive. In one embodiment, the chamber has a radius greater than 50 feet.

According to various embodiments of the present disclosure, the chamber opening size may be selected according to desirable traits of the airfoil. The chamber opening may be optimized by altering its length along the chamber (i.e. its horizontal size) or its vertical size. In some embodiments, the horizontal size of the chamber opening is approximately 100% of the chamber length. In other embodiments, the horizontal size of the chamber opening is between 75% and 100%, inclusive, of the chamber length. In other embodiments, the horizontal size of the chamber opening is between 50% and 75%, inclusive, of the chamber length. In other embodiments, the horizontal size of the chamber opening is between 25% and 50%, inclusive, of the chamber length. In other embodiments, the horizontal size of the chamber opening is less than 25% of the chamber length.

In various embodiments, the vertical size of the chamber opening may be described as a proportion of the forward-facing area of the chamber. For example, in some embodiments, the vertical size of the chamber opening is approximately 100% of the chamber height. In this embodiment, the chamber opening would have a vertical expanse that is approximately equal to the vertical height of the chamber itself. In other embodiments, the vertical size of the chamber opening is between 75% and 100%, inclusive, of the chamber height. In other embodiments, the vertical size of the chamber opening is between 50% and 75%, inclusive, of the chamber height. In other embodiments, the vertical size of the chamber opening is between 25% and 50%, inclusive, of the chamber height. In other embodiments, the vertical size of the chamber opening is less than 25% of the chamber height.

According to some embodiments of the present disclosure, the chamber comprises a stationary scoop opposite the airfoil surface, such that fluid passing near the airfoil pressure surface is directed into the chamber. In other embodiments, the chamber comprises a fluid intake section that can be retracted and/or disengaged, such that when the fluid intake section is engaged, fluid approaching the airfoil may be directed toward the chamber, but when retracted and/or disengaged, the chamber will not have an effect on incoming airflow. In such embodiments, the use of the chamber can thus be selectively engaged or disengaged as desired. In embodiments, the intake section comprises louvers that may be selectively opened or closed. In other embodiments, the intake section comprises louvers that may selectively be moved into position to direct fluid approaching the airfoil into the chamber, or out of said position thereby essentially blocking fluid entry into the chamber.

In various embodiments of the present disclosure, a chamber and chamber opening on the pressure surface, as described herein, may result in an increase in the size of the fluid boundary layer along the airfoil pressure surface. In other embodiments, the chamber and chamber opening may induce and/or increase a separation of the fluid boundary layer from the airfoil pressure surface.

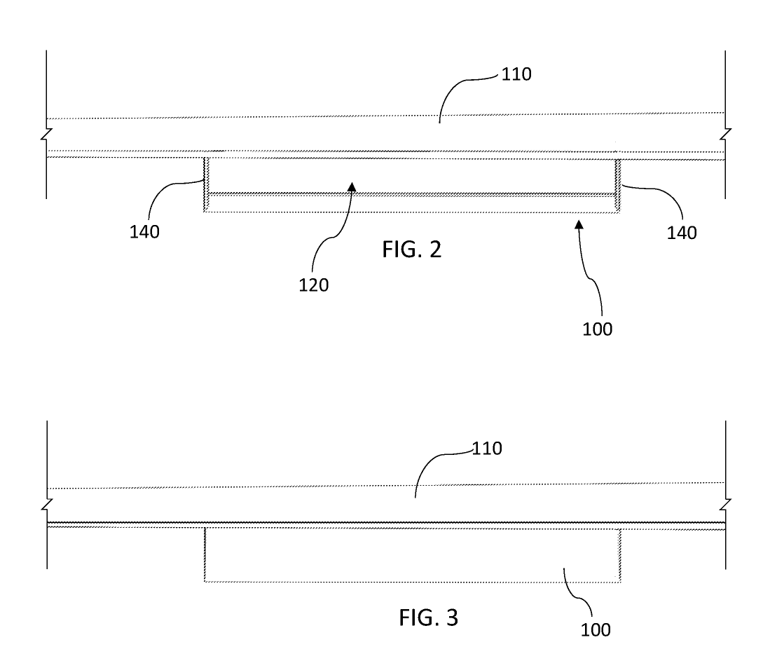

Referring to FIG. 2, various embodiments of the present disclosure comprise lateral barriers 140 fixed at ends of the chamber 100. Said lateral barriers 140 may act to close off the chamber 100 ends to fluid ingress and/or egress. In some embodiments, barriers 140 are essentially parallel to the chord of the airfoil 110. In some embodiments, barriers 140 are essentially parallel to the direction of travel of the airfoil 110. In some embodiments, barriers 140 comprise essentially planer elements that are fixed to various inward-facing surfaces within the chamber 100 and fixed to points at the pressure surface 113 that are forward of the chamber 110 and/or barriers 140. In other embodiments, one or more barriers 140 comprise elements of any one of a variety of shapes and/or sizes that are adapted to maintain air pressure within the chamber 100.

Referring back to FIG. 1, some embodiments of the present disclosure include lateral intermediary barriers 150 between the ends 140 of the chamber 100, for example dispersed along the span of the airfoil 110. In embodiments, intermediary barriers 150 may have a similar size, shape, and/or structure to end barriers 140. Such intermediary barriers 150 may act to prevent or reduce fluid ingress and/or egress between sections within the chamber 100 and/or to prevent or reduce fluid ingress and/or egress to or from the chamber 100 itself. Said lateral intermediary barriers 150 may form divisible sections within the chamber 100 so as to maintain the desired fluid pressures between sections within the chamber 100, for controlling the fluid barrier size in front of the chamber 100.

In various embodiments of the present disclosure, lateral end barriers 140 and/or lateral intermediary barriers 150 may add structural rigidity to the airfoil 110 and/or chamber 100 by acting as crossmembers to the airfoil 110.

In one class of embodiments, the airfoil comprises a rotor or turbine blade, or other similar apparatus involving radial motion of the airfoil. In such embodiments, end lateral barriers and/or intermediary lateral barriers may be shaped and/or angled inward to effectively mitigate escape of pressurized fluid within each chamber section, to counter centrifugal forces acting on the fluid due to rotation of the airfoil.

In some embodiments of the present disclosure, the chamber comprises any one of a variety of shapes and/or cross-sectional profiles. In one example embodiment, the chamber comprises a cylinder with an elliptical cross section. In one example embodiment, the chamber comprises a tapered shape, such that horizontal cross sections are progressively smaller at each end. In such a tapered chamber, the tapered ends may function as lateral end barriers.

In embodiments of the present disclosure, end and/or intermediary barriers may allow the chamber to maintain fluid pressure relatively higher than ambient pressure and/or pressure at the airfoil suction surface, which may act to increase the pressure at the airfoil pressure surface. Such an increase in pressure at the airfoil pressure surface may act to increase the lift generated by the airfoil.

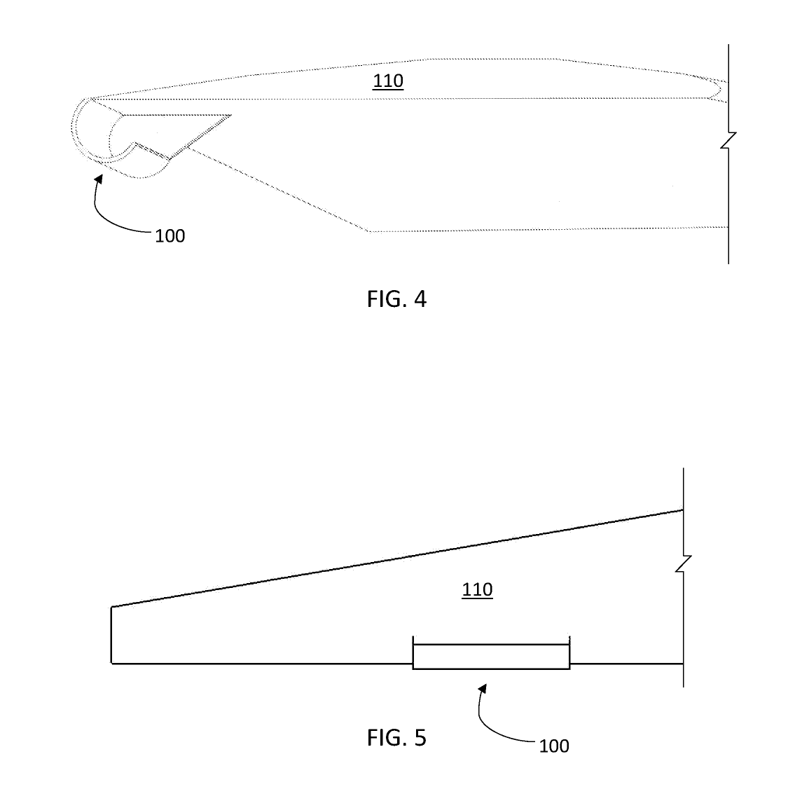

Referring to FIG. 3 and FIG. 4, some embodiments of the present disclosure comprise a chamber 100 having a roughly cylindrical shape with a length roughly parallel to the span of the airfoil 110. Other embodiments comprise a chamber having a shape as may be appropriate to fit the profile of the airfoil. In some embodiments of the present disclosure, the chamber comprises a length approximately equal to the airfoil span. Referring to FIG. 5, some embodiments of the present disclosure comprise a chamber 100 having a length that is less than the airfoil 110 span. In one example embodiment, the chamber comprises a length that is 75% to 100% of the airfoil span. In one example embodiment, the chamber comprises a length that is 50% to 75% of the airfoil span. In one example embodiment, the chamber comprises a length that is 25% to 50% of the airfoil span. In one example embodiment, the chamber comprises a length that is less than 25% of the airfoil span.

According to some embodiments of the present disclosure, multiple distinct chamber segments may be placed along an airfoil length. For example, an airplane wing may have several chambers. Said chambers may be disposed between other elements on the wing, such as the engine nacelle and/or engine thrust path, ailerons, flaps, slats, and other control surfaces or wing elements. As would be understood by a person of ordinary skill in the art having the benefit of this disclosure, the cumulative effect of multiple chamber segments may be equivalent to a single, larger chamber having equivalent dimensions to that of the cumulative length and/or height of the multiple chamber segments.

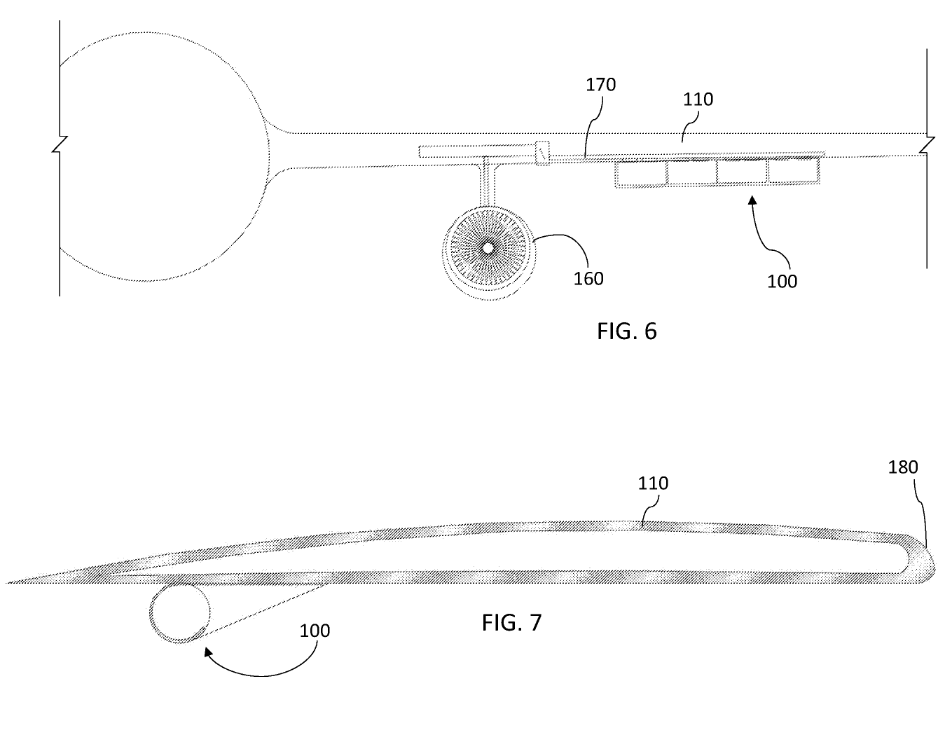

Referring now to FIG. 6, in one embodiment of the present disclosure, air bleed output from one or more engines 160 is fed into an airfoil chamber 100 to increase pressure therein. In one embodiment, high pressure fluid output is directed from an engine 160 into an airfoil chamber 100. In various embodiments, said output is directed into the airfoil chamber 100 via a redirect channel 170. In one embodiment, the redirect channel 170 comprises an open channel with vanes and/or fins to redirect said output. In another embodiment, the redirect channel 170 comprises an enclosed chamber.

In some embodiments of the present disclosure, an airfoil is constructed with a chamber as described herein. In other embodiments, a chamber may be retrofitted to an existing airfoil.

In various embodiments, an airfoil chamber is manufactured from one or more of a variety of materials known to exhibit desirable characteristics of strength, rigidity, and durability. In some exemplary embodiments, an airfoil chamber is manufactured from various metals or alloys thereof, carbon fiber, fiberglass, and/or combinations thereof. In embodiments, an airfoil chamber is a structural member of the airfoil.

As depicted in FIG. 7, according to some embodiments of the present disclosure, the airfoil 100 is asymmetric. In particular, such embodiments have a leading-edge 180 curve shape adapted to deflect air toward the chamber 100 on the pressure side 113 of the airfoil. In some embodiments, the lower half of the leading-edge 180 curve is smaller in size than the upper half of the leading edge 180 curve (i.e., the curvature at the pressure surface leading edge 180 has a smaller radius of curvature than that of the curvature at the suction surface 116 leading edge), which may result in increased airflow to the pressure surface 113 of the airfoil 110. In particular, the shape of the airfoil leading edge 180 may enhance the effectiveness of the chambers 100 by affecting the airflow directed toward the chamber opening 120. In some cases, it may be desirable that the leading edge 180 does not disrupt laminar air flow of fluid that approaches the airfoil 110 and passes toward the chamber opening 120.

In operation, an airfoil chamber 100 with an opening 120 facing the airfoil leading edge 180 may increase the lift generated by the airfoil 110. In some embodiments, fluid flowing into the chamber 100 may form a fluid vortex within the chamber 100. Under some circumstances, the vortex of fluid may increase fluid pressure below the pressure surface 113 of the airfoil 110, leading to increased lift.

The airfoil vortex may allow aerodynamic movement of air as it approaches the airfoil 110 to pass around the vortex effect as though it was a rigid surface but with reduced drag. In some cases, the vortex effect may result in efficiency gains as the airspeed increases. These drag reduction and other efficiency gains may be relative to a standard airfoil having deployed flaps, for example on an airplane wing.

Although the present disclosure is described in terms of certain preferred embodiments, other embodiments will be apparent to those of ordinary skill in the art, given the benefit of this disclosure, including embodiments that do not provide all of the benefits and features set forth herein, which are also within the scope of this disclosure. It is to be understood that other embodiments may be utilized, without departing from the spirit and scope of the present disclosure.

What is claimed is:

1. An airfoil comprising:
a chamber and
a chamber opening;
wherein the chamber opening faces a forward direction of travel of the airfoil.

2. The airfoil of claim 1, wherein the chamber has a radially symmetrical cylinder shape.

3. The airfoil of claim 1, wherein the chamber has an elliptic cylinder shape.

4. The airfoil of claim 1, further comprising an end barrier at an end of the chamber, wherein the end barrier is essentially perpendicular to a length of the chamber and essentially parallel to the forward direction of the airfoil.

5. The airfoil of claim 1, further comprising an intermediary barrier within the chamber, wherein the intermediary barrier is essentially perpendicular to a length of the chamber and essentially parallel to the forward direction of travel of the airfoil.

6. The airfoil of claim 1, further comprising an intermediary barrier within the chamber, wherein the intermediary barrier is angled relative to the forward direction of travel of the airfoil.

7. The airfoil of claim 1, wherein the chamber is located forward from a trailing edge of the airfoil.

8. The airfoil of claim 1, wherein the chamber is at a trailing edge of the airfoil.

9. The airfoil of claim 1, wherein the chamber opening is at a pressure surface of the airfoil.

10. The airfoil of claim 1, wherein the chamber has a cumulative length equivalent to greater than 0% of a span of the airfoil and less than 100% of a span of the airfoil.

11. The airfoil of claim 1, further comprising a redirect channel adapted to direct fluid output from an engine into the chamber.

12. A method of generating lift comprising:
directing an aircraft, the aircraft having an airfoil, the airfoil comprising:
a chamber and
a chamber opening;
wherein the chamber opening faces a forward direction of the aircraft.

13. The method of claim 12, further comprising:
engaging the chamber opening to direct fluid into the chamber, thereby decreasing the airspeed of the aircraft.

14. The method of claim 12, wherein the chamber further comprises an end barrier at an end of the chamber, wherein the end barrier is essentially perpendicular to a span of the airfoil and essentially parallel to the forward direction of the airfoil.

15. The method of claim 12, wherein the chamber is forward from a trailing edge of the airfoil.

16. The method of claim 12, wherein the chamber is at a trailing edge of the airfoil.

17. The method of claim 12, wherein the chamber opening is at a pressure surface of the airfoil.

18. The method of claim 12, wherein the chamber has a cumulative length equivalent to greater than 0% of a span of the airfoil and less than 100% of a span of the airfoil.

19. The method of claim 12, further comprising directing fluid output from an engine into the chamber via a redirect channel.

20. An airfoil comprising:
a chamber enclosure;
a chamber opening, wherein the chamber opening faces a forward direction of the airfoil; and
an end barrier at an end of the chamber, wherein the end barrier is essentially perpendicular to a length of the chamber and essentially parallel to the forward direction of the airfoil.
